(19) United States
(12) Patent Application Publication
(10) Pub. No.: US 2026/0346065 A1
(43) Pub. Date: Nov. 5, 2026

(54) Portable Battery Thermal Runaway Suppression Container

(71) Applicant: Stephen Knight, Blanchard, OK (US)

(72) Inventor: Stephen Knight, Blanchard, OK (US)

(21) Appl. No.: 19/729,232

(22) Filed: May 26, 2026

Related U.S. Application Data
(63) Continuation-in-part of application No. 18/831,459, filed on Jan. 28, 2025.

(51) Int. Cl. A62C 3/16; A62C 2/06; A62C 31/28

(52) U.S. Cl. CPC A62C 3/16; A62C 2/06; A62C 31/28

(57) ABSTRACT

An electrochemical fire suppression liquid used in conjunction with a portable locking fire containment device for containment, suppression, extinguishing and halting of a thermal runaway event of an internal ionic battery within an electronic device by complete emersion of the electronic device and battery within the electrochemical fire suppression liquid chemical within the portable locking fire containment device until the battery activity is permanently ceased.

### CROSS REFERENCE TO RELATED APPLICATIONS

This application is a continuation-in-part of U.S. patent application Ser. No. 18/831,459 filed on Jan. 28, 2025, by the same inventor.

### I. BACKGROUND OF THE INVENTION

### 1. Field of Invention

An ionic battery extinguishing liquid, thermal liner, and portable fireproof container contains, for extinguishing, a failing ionic battery of device containing one, experiencing a thermal runaway. The battery or device containing the battery is emersed and flooded with the extinguishing liquid which inactivates the ionic battery, extinguishes the ionic event, and terminates any further increase in heat level of the ionic battery and the electronic device and further deactivates the ionic battery by halting the exchange of cathode-anode electronic current supply.

### 2. Description of Prior Art

A preliminary review of prior art patents was conducted by the applicant which reveal prior art patents in a similar field or having similar use. However, the prior art inventions do not disclose the same or similar elements as the present battery fire suppression system, nor do they present the material components in a manner contemplated or anticipated in the prior art.

In U.S. Pat. No. 11,289,731 to He, a lithium secondary batter containing an anode, a cathode, a porous separator electrolyte element disposed between the cathode and anode and a cathode protecting layer bonded or adhered to the cathode with the cathode protecting layer comprising a lithium ion-conducting polymer matrix or binder and inorganic material particles that are dispersed in or chemically bonded by the polymer matrix, melts, contracts or collapses when under extreme heat causes by dendrite or nail penetration prevents massive internal shorting or fire. An emergency water bath container is disclosed in U.S. Pat. No. 10,722,741 to Lian, which contains an amount of water within a boxed container with a lid, which may enclose a failing battery, which heats the water and causes a breakdown of a pouch containing a fire-fighting foaming agent which, when released from a cartridge at an elevated heat caused by introduction of the battery within the water, mixes with the water and suppresses further elevated heat from the battery.

In a first Korean patent, as best translated from the issued patent publication of KR 20070008087, (inventor unknown) a lithium secondary battery comprises a thermally degrading capsule containing an anti-overcharging agent which increase an inner resistance or impedance of the battery by electrochemical polymerization of abnormal working condition of the battery, wherein the anti-overcharging agent is one or more from the group consisting of biphenyl, terphenyl and cyclohexyl phenyl. A second Korean patent, as best translated from the issued patent publication of KR102064416B1, (inventor unknown), a lithium-based fire extinguishing agent is used to extinguish a fire from lithium based batter and includes a powdered fire extinguishing agent, a solid aerosol extinguishing agent and a liquid fire extinguishing agent. An included method using the ingredients sprays the solid aerosol extinguishing agent by vaporizing the solid aerosol agent with the extinguishing gas from a solid aerosol extinguishing part, sprays the powder fire extinguishing agent and sprays the liquid extinguishing agent when the fire occurs in the lithium-based battery. In JP6042734B2, which appears to have been filed by Hochiki Corp. an published on12/14/2016, discloses a cabinet wherein a lithium-ion battery which is deactivated using an explosive powder, disclosed as gunpowder, is exploded within the container creating a percussive extinguishment of any potential lithium-ion battery fire event. In a Chinese patent, published in 2021 as CN 109316687B to Huawei Technologies Co. Ltd., a battery management system discloses a gas sensor detecting the presence of explosive gasses from a battery module, such gases including Hydrogen, methane, ethane, ethylene and carbon monoxide, which further activates a discharge of fire extinguishing gases to the battery when the limits of acceptable level of explosive gases is reached.

None of the previous art discloses a device containing the liquid extinguishing agent as disclosed in the present invention which is introduced to the cathode and anode portion of ionic battery to flood the battery containing compartment of an electronic device within a fire proof container or envelope having an internal packaged liquid extinguishing agent, the container or envelope containing an electronic device with an immediate defective ionic battery event is emersed wholly within the liquid extinguishing agent in a secured container.

### II. SUMMARY OF THE INVENTION

Ionic batteries are seeing a rapid rise in the market to provide stored electrical energy for everything from medical device, small electronics, rechargeable vehicles and even large electronics and home energy storage.

Metal ion batteries comprise essentially four components. A cathode stores the metal ions and releases charged ions when the battery is charging. An anode releases ions when the battery is discharging. A separator provides movement from the anode to the cathode while preventing a short circuit. An electrolyte acts as a transporter of ions within the ionic battery during charging and discharge use. At present, the most used ionic battery is the lithium-ion battery. These batteries have the capability to be charged and discharged multiple times, each charge and discharge called a cycle, and lithium has a very high number of cycles over its lifetime. Sodium is being developed and other reactive metals which are being developed include potassium, magnesium, calcium, zinc and aluminum. Most common use at this time would be the present suppression as it relates to lithium-ion batteries, but in the event these other metallic ion batteries would have a potential for ignition or fire hazard, it is contemplated that the present suppression materials and systems might be employed synonymously with those metal ion batteries, also.

It is well known in the metal-ion industry that fires can occur as a direct result of ionic batteries catching fire or obtaining a level of heat which would ignite surrounding materials. This event is known in the industry as thermal runaway, which is caused by an initiation event. It is a phenomenon in which a lithium-ion cell enters a state of uncontrolled self-heating. If the excessive heat generation is not halted, the condition will worsen into a chemical reaction that further releases thermal energy, melting the separator causing an internal short circuit. This is the tipping point after which the thermal runaway occurs in a continuous feedback loop. This commonly causes an ignition of other adjacent cells, propagating these other cells into a thermal runaway and destroy an entire battery pack. Causes of these thermal runaways can be initiated by environmental means, including excessive heat, charging in a cold environment, or exposure to salt water. Mechanical disruption caused by dropping, crushing, indenting, chocking, vibration, impact or penetration can cause separator failure. Electrical overcharge is a potential initiating event as is electrical over-discharge. Manufacturing and design defects from cheaply made batteries are a known reason for lithium-ion battery fires. Aging or use beyond the life of the battery may also cause a fire event and failure.

All of these above causes of thermal runaway must be considered and the present components, materials and processes disclosed are intended to address these thermal runaway damages and minimize the risk of metal ion battery fires and damage to not only electronic devices but surrounding environments wherein these electronic metal ion battery devices are used, including transportation vehicles during passage or transport.

### III. DESCRIPTION OF THE DRAWINGS

The following drawings are submitted with this utility patent application.

FIG. 1 is an upper perspective view of the battery containment chest with phantom lines showing an accessory fire extinguisher and mounting bracket mounted to a locking lid secured to the lower reinforced bin.

FIG. 2 is a rear perspective view of the containment box showing the portable trailer affixed to a rear panel of the lower reinforced bin and phantom lines showing the accessory fire extinguisher and mounting bracket mounted to the locking lid.

FIG. 3 is a diagram of the several types of internal fireproof liners which may be installed within the cavity of the lower reinforced bin, including, from left to right, one containing an upper fill cap and a pull tab opening, on having a zippered opening, one as a flat panel with an upper fill cap and one being a vertical containment liner with an upper zip-lock closure.

FIG. 4 is a cross sectional view along lines of the containment box with the upper locking lid engaged, indicating an electronic device shown in phantom lines, with a ruptured containment liner and expelled battery extinguishing liquid fully immersing the electronic device within the inner cavity of the lower reenforced bin.

FIG. 5 is an exploded view of the lower reenforced bin, the upper locking lid and phantom lines indicating the accessory fire extinguisher and mounting bracket.

FIGS. 6A-6D show the lid locking bracket handle in a closed position, a released position, a disengaged position and a fully open position from a side locking base member on the lower reenforced bin.

FIG. 7 is a view of the battery containment chest ready for placement within an optional fire proof vault is the local vicinity where an ionic battery operated electronic device use in contemplated.

FIGS. 8A-8D are optional embodiments of a fillable or extinguishing liquid containing fire-proof bladders, with 8A being a rectangular bladder with an upper pull tab opening and a fillable liquid opening, 8B representing a horizontal flat bladder defining an upper pull tab and a fillable liquid opening for a briefcase-style battery containment chest, 8C being another flat bladder containing only a fillable liquid opening, and 8D showing an envelope bladder with an upper zipper opening.

### IV. DESCRIPTION OF THE PREFERRED EMBODIMENT

Ionic battery thermal runaways have been a common occurrence since the advent of this type rechargeable battery introduction into electrical devices. Most common are the lithium-ion batteries which have the capacity to be recharged repeatedly over their useful lives-upward of 10,000 recharges before they become depleted. New ionic batteries are currently under development with hopes for a newer and better rechargeable battery. It is also a less common occurrence that these batteries can become defective as previously highlighted, resulting in thermal runaway events and even a consuming fire that destroys not only the electronic device, but surrounding combustible materials in near proximity. Damage to the battery, overheating or extreme conditions can lead to breakdown of the Solid Electrolyte Interphase (SEI) layer on the anode, which starts at around 167 °F (75 °C). As the SEI layer disintegrates, heat is generated through chemical reactions. The anode reaction produces heat exponentially, raising the temperature. At approximately 230 °F (110 °C), the organic solvents in the electrolyte break down, releasing flammable gases. Several reactions occur during this thermal runaway event, as follows:
a. Decomposition of the SEI Layer: The SEI layer decomposes, releasing gases and heat.
b. Electrolyte Decomposition: Organic solvents in the electrolyte break down, producing flammable gases like ethylene.
c. Lithium Reaction with Solvent: Lithium ions can react with the solvent, generating heat and additional lithium salts.
d. Short Circuit Reaction: When the separator melts, a short circuit occurs between the anode and cathode, discharging energy uncontrollably.
e. Decomposition of Cathode Materials: The metal oxide cathode starts to decompose, releasing oxygen gas that can fuel combustion.
f. Formation of Toxic Gases: Additional toxic gases may form from the decomposition of materials, creating hazardous conditions.
g. Combustion Reactions: The released flammable gases ignite, leading to combustion that sustains the fire.

This has been proven and is commonly the manner in which lithium-ion batteries react in the thermal runaway occurrences.

In addition, pressures may build up in the batteries during the runaway thermal event which can result in a explosion, which may include the following:
a. Gas Production: The electrolyte decomposition and the SEI layer generate flammable gases. As these gases accumulate, they increase the battery cell's internal pressure.
b. Electrolyte Breakdown: The breakdown of organic solvents in the electrolyte forms additional gases, further increasing pressure.
c. Melting of the Separator: When the polymer separator melts due to high temperatures, it can cause a short circuit, leading to rapid energy discharges and further gas generation, exacerbating pressure buildup.
d. Thermal Expansion: The heat generated from the reactions causes the gas within the battery to expand, increasing the pressure even more.

Dangers which can result from excessive heat and temperature have been know to pose the following risk to the local area as well as to the environment. These critical risks may include:
a. Risk of Explosion: High internal pressure can rupture the battery casing, potentially causing an explosion that can spread fire and toxic materials.
b. Fire Propagation: If the battery bursts, it can release flammable gases and materials into the environment, igniting nearby combustibles and escalating the situation.
c. Safety Hazard for Firefighters: Understanding pressure buildup helps firefighters anticipate the potential for violent reactions and explosions, allowing them to take appropriate precautions and measures when responding to incidents involving lithium-ion
d. Compromised Containment: Once the battery's structural integrity is compromised, containment becomes difficult, making it essential to manage pressure effectively to prevent further hazards.

The solution, components and methods of use as disclosed below are intended to stop the thermal runaway upon immediate presentation to the ionic battery or device containing the ionic battery in the following physical and chemical manners. First, there is an immediate cooling effect. The specialized solution used in firefighting is highly endothermic, meaning it absorbs heat from the battery almost instantly. This cooling effect helps slow down the chemical reactions that generate heat. Second, by neutralization of the electrolyte when the solution penetrates the affected battery cells and disrupts the combustion reactions within the electrolyte. By neutralizing the electrolyte, it halts the chemical processes that contribute to further heat generation. Third, by the formation of a porous chemical barrier that condenses and traps the toxic gases produced during thermal runaway. This barrier helps prevent the spread of heat and additional reactions within the battery, reducing the risk of fire spreading to surrounding materials. Fourth, by stabilizing the battery or device containing the battery after extinguishing the fire, injecting a more viscous solution stabilizes the battery, minimizing the risk of further mechanical failures and potential reignition during transport.

Having identified the risk and circumstances encountered with ionic batteries and the devices operated by these batteries, the present chemical fire suppression system involves the use of an electrochemical ionic fire suppression liquid 100, preferably liquid ethylene glycol monophenyl ether (hereinafter, EGME identifying the electrochemical ionic fire suppression liquid as reference number 100), a/k/a 2-Phenoxyethanol, which is a stable liquid chemical known for its wetting qualities and which is not considered hazardous by the 2012 OSHA Hazard Communication Standards, 29 CFR 1919.1200. It is further described as a Florine Free Solution used in extinguishing Lithium-ion fires. It is not listed as an extremely hazardous substance (SARA Section 355), is not listed as a toxic chemical (SARA Section 311/312/313), is not listed as a Hazardous Air Pollutant (HAPs), and is not listed as a toxic chemical (Toxic Substances Control Act).

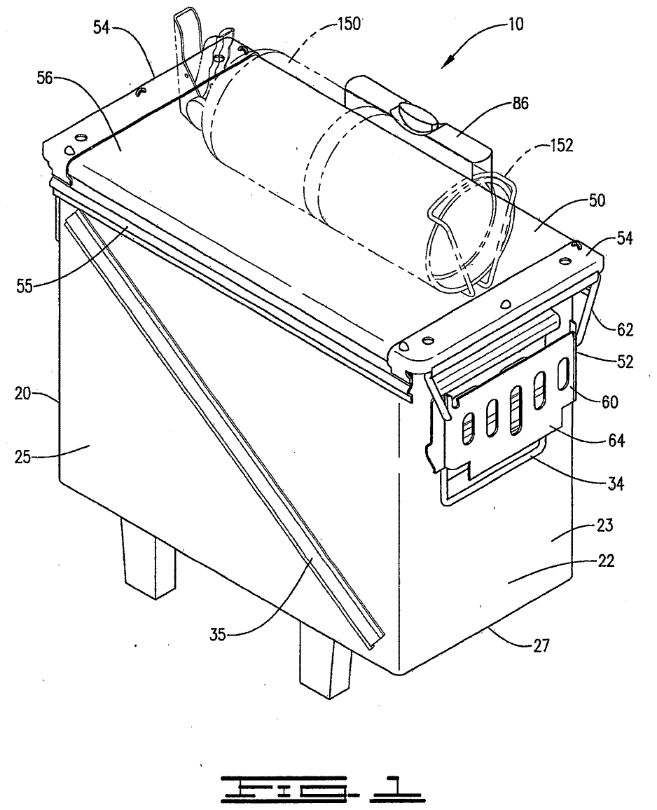

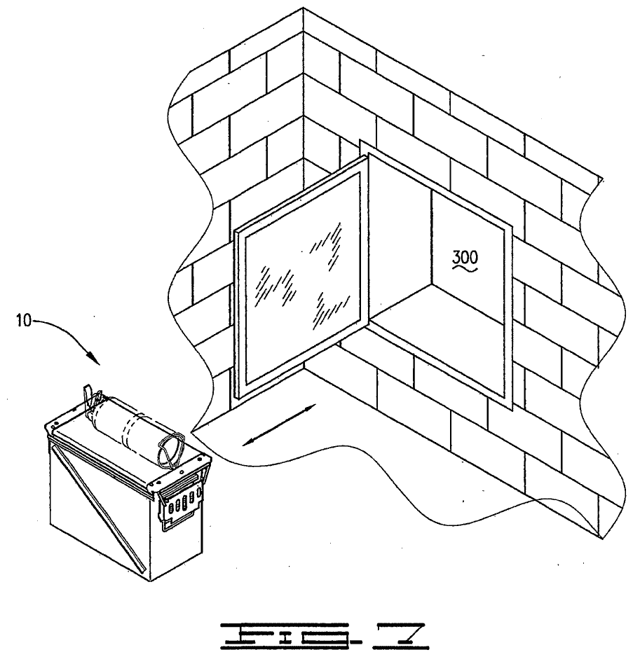

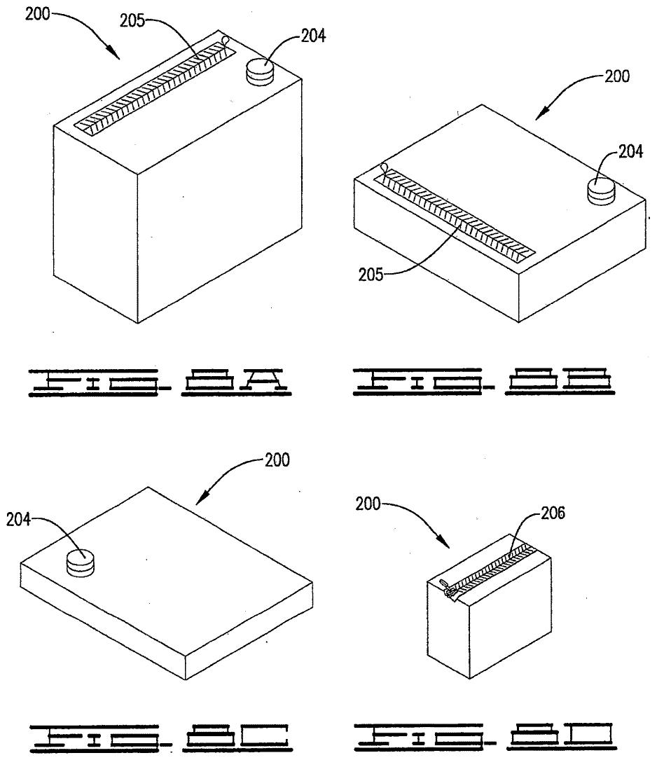

The EGME 100 is used in conjunction with a locking fire containment box 10, shown in FIGS. 1-8D of the drawings. The locking fire containment box 10 is a metal or fire-resistant container with a locking lid designed to contain an electronic device X experiencing a thermal runaway event that can erupt into a fire and cause damage to its surroundings, to retain it in the EGME 100, and keep it from receiving oxygen, thus depriving the electronic device X experiencing thermal runaway from any fuel.

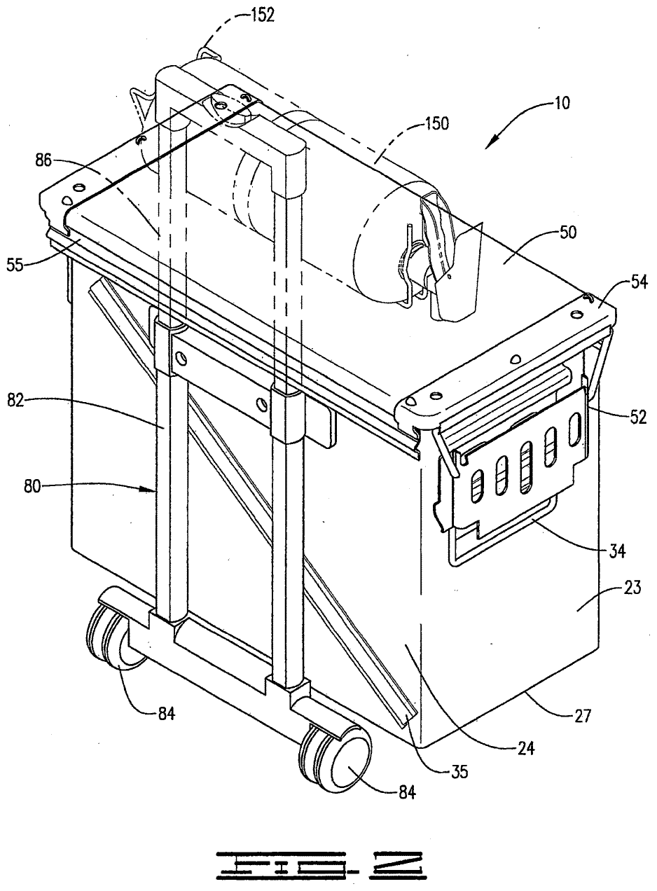

The locking fire containment device 10, shown in FIGS. 1-8D, comprises a battery containment chest 20 defining an inner cavity 21, a locking lid 50, at least one locking lid bracket handle 52 engaging at least one containment box locking base 30 and an internal fireproof liner 200 containing a quantity of EGME 100. Optional features may include a rear panel 24 mounted portable truck 80, FIG. 2, an accessory fire extinguisher 150 mounted to an upper surface 56 of the locking lid 50 by a mounting bracket 152, an a fire-proof vault 300 in a wall or vehicle compartment within which the locking fire containment device 10 may be placed a second level of protection after an electronic device X experiencing a thermal runaway event can be contained until an emergency fire team can remove the electronic device X from within the containment vault 300.

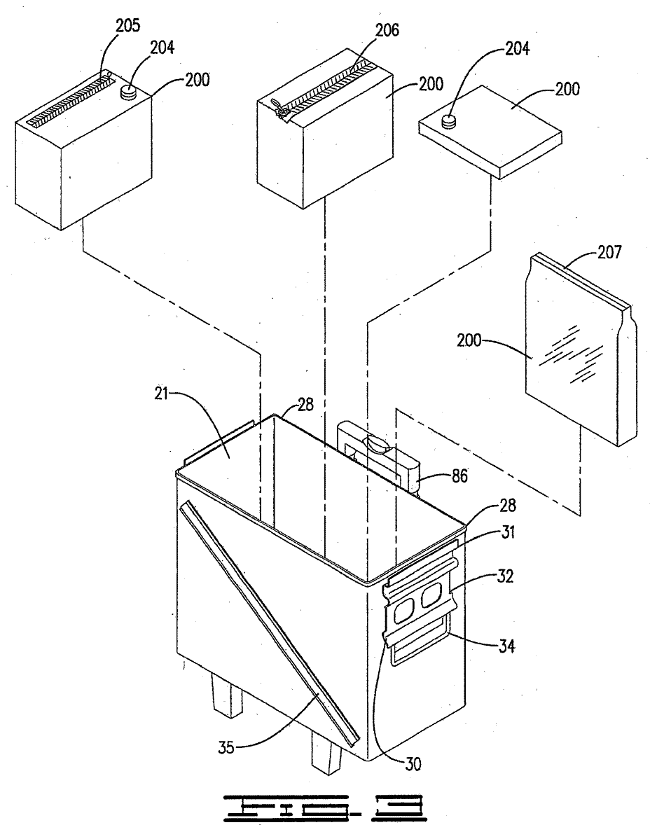

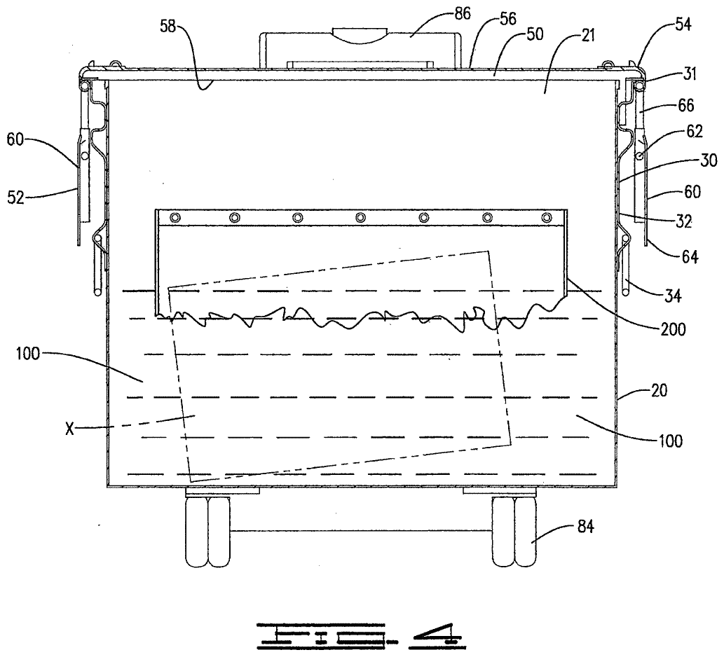

The battery containment chest 20, FIGS. 1-5 and 7, defines a shaped enclosure having an outer surface 22, side panels 23, a front panel 25 and a floor 27, defining the inner cavity 21. Along a top edge 26 of the battery containment chest 20 is a reinforced upper rim 28, FIG. 3. A stabilizing bar 35 is also optional shown in FIGS. 1 and 3 which enhances one or more sides to which it is applied. On at least one side panel 23, at least one containment box locking base 30 is installed. Two containment box locking bases 30 may be installed on each side panel, as shown in FIG. 4 and as indicated in FIGS. 1-2. Alternatively, there may be only one containment box locking base 30 in an embodiment not shown, which would include a hinge on a side opposite a single containment box locking base 30, and corresponding locking lid bracket handle 52, thus the inclusion of the term “at least one” in reference to the locking lid bracket handle 52 and mating containment box locking base 30 pairings. The battery containment chest 20 is rated and constructed to resist ballistic inner explosions which can occur in some rare instances where an ionic batter is experiencing a thermal runaway event, once again bolstered by the inclusion of one or more stabilizing bars 35.

The locking lid 50, FIGS. 1, 2, 4, 5, and 6A-6D, conforms is size and shape to the reinforced upper rim 28 of the battery containment chest 20. The locking lid 50 provides a reinforced end margin member 54 firmly secured to the upper surface 56 of the locking lid 50. On two sides not related to the reinforced end margin members 54, a respective depending contoured lip 55 extends downward from a lower surface 58 of the locking lid 50, corresponding sides that are not supplied with at least one locking lid bracket handle 52. This engagement between the contoured lips 55, the reinforced upper rim 28 and the lower surface 58 of the locking lid 50 forms an airtight seal preventing the entry or exit of air, heat release, containment of gas or vapors or loss of the contained EGME 100.

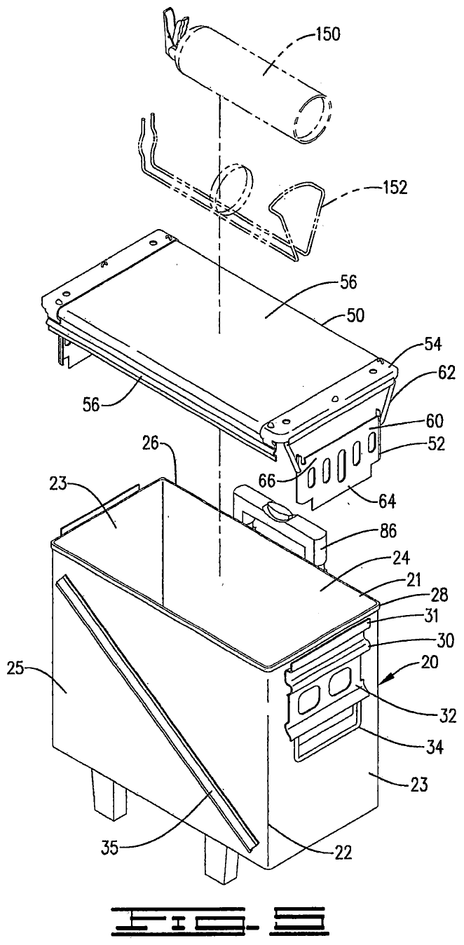

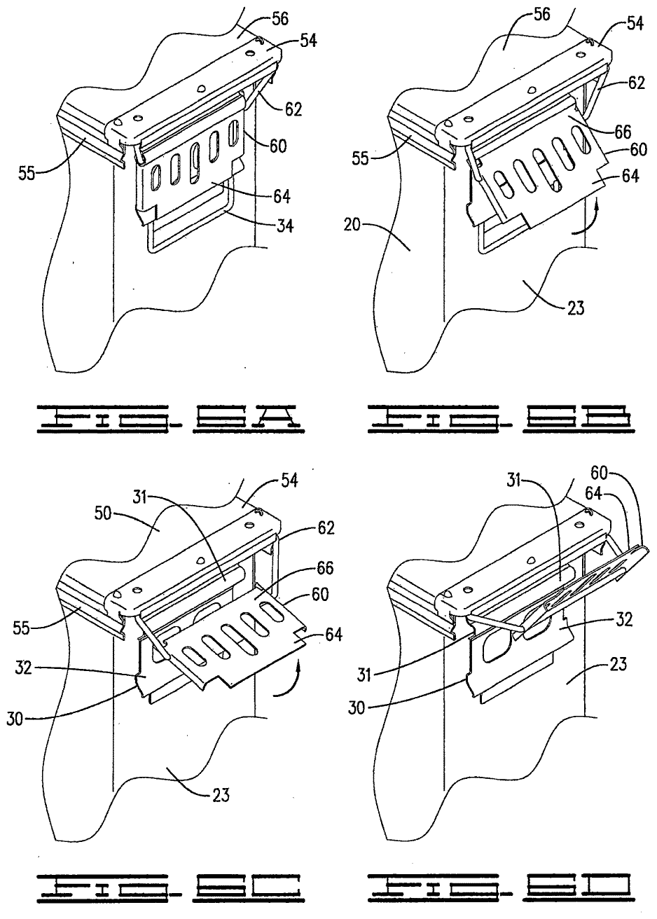

The at least one locking lid bracket handle 52, FIGS. 1-7, engages the containment chest locking base 30 as shown in a closed position in FIGS. 1, 2, 4, 6A and 7. The fully open position is shown in FIGS. 3, 5, and 6D. A released position is shown in FIG. 6B while a disengaged position is shown in FIG. 6C. A lid lock plate 60 depends from the reinforced end margin member 54 by a side bracket 62 that is in pivotal engagement with the reinforced end margin member 54, the lid lock plate 60 further defining a lower grip tab 64. Within the lid lock plate 60, FIGS. 3, 5, and 6D is an upper handle lock extension 66. The containment chest locking base 30 defines an upper lock flange 31 and a side engagement plate 32 that is secured to the respective side of the battery containment chest 20. A lower containment box handle 34 is located below the containment chest locking base 30, shown in FIGS. 3 and 5, enabling a user to pick up and carry the battery containment chest 20 with or without the locking lid 50 installed.

The locking lid 50 engages and secures to the battery containment chest 20 by attachment of the locking lid bracket handle 52 within the upper lock flange 31 of the containment chest locking base 30. Engagement of the locking lid bracket handle 52 and containment chest locking base 30 is accomplished by following steps illustrated stepwise in FIGS. 6A-6D in reverse order. Disengagement is accomplished by following the steps shown in FIGS. 6A-6D in order. To engage the locking lid 50 to the battery containment chest, the upper handle lock extension 66 is positioned underneath the upper lock flange 31 at an angle, FIGS. 6C to 6B, opposite the movement arrows. The lid lock plate 60 is then pushed against the side engagement plate 32 rotating the upper handle lock extension 66 securely within the upper lock flange 31, elevating the upper lock handle extension 66 within the upper lock flange 31, FIG. 6A. It should be noted that other embodiments of the locking lid bracket handle 52 and the containment chest locking base 30 can be presented using any other conventional lid locking means in many other products. However the embodiment in the drawing figures is similar to a lid locking means used in military ammunition boxes that seem to work well with containment of explosive ordinance or other ballistic materials, which is similarly attempted to averted potential dangers in the present locking fire containment device 10.

The mounted portable truck 80, FIGS. 1-5, is intended for providing the locking fire containment device 10 in a portable manner. The mounted portable truck 80 defines a frame 82 attached to the rear panel 24 of the battery containment chest 20, the mounted portable truck 80 further defining a set of lower wheels 84 extending below the floor of the battery containment chest 20, and an elevating upper handle 86 extendable above the locking lid. Without the mounted portable truck 80, a user would have to lift and carry the entire locking fire containment box 20 to a location before and after the use for containment of an electronic device X containing a battery experiencing a thermal runaway event, which is dangerous, or requiring a user to take an electronic device X experiencing a thermal runaway event to the locking fire containment device 10, which could be even more dangerous. That electronic device X with the ionic battery in a thermal runaway is generally hot with temperatures arising quickly. The mounted portable truck 80 allows one to roll the locking fire containment box 10 to the electronic device X and to remove it safely upon containment of the electronic device without heat or other danger exposure. This is most useful in situations where the locking fire containment device 10 is used in a private or public transportation vehicle, like an airplane, bus, train or military craft. This portability aspect is also most useful in an office setting where occupants are trained to locate this device also with other safety objects including fire extinguishers, fire hoses, emergency activation features, defibrillators and other emergency type equipment found in commercial and public places, most likely accompanied by location signs and emergency warnings and operational placards. Human resource training is also helpful for public and private usages.

The accessory fire extinguisher 150 and mounting bracket 152, FIGS. 1-2 and 5, is provided as a contingency for certain added safety when handling an electronic device X with an internal battery undergoing a thermal runaway event. When a battery goes into this phase, it gets hot-so hot that it may be dangerous to handle the electronic device X and certainly too hot to handle the battery. As mentioned earlier, thermal events can generate heat over 230 °F, causing a release of combustible gases, explosion and fire. This can cause burns to a person handling the electronic device or battery in a state of thermal elevation. The fire extinguisher 150 and bracket 152 to temporarily secure the extinguisher with the locking fire containment device 10 to spray the contents on the device to cool it down enough to be placed within the inner cavity 21 of the locking fire containment device 10 prior to emersion in the EGME 100 to bathe, suppress, suffocate and to halt the thermal runaway event. This is purely an option, which is why the fire extinguisher 150 and bracket 152 are shown in phantom line in FIGS. 1, 2, 5 and 7, as to optimal placements. Also suggested for proximity location would be fire-proof gloves and protective eyewear which are common items helpful to emergency situations, not shown.

The fire-proof liners 200, FIGS. 3, 4 and 8A-8D, would be made from a fire proof materials selected from a group comprising Aramid (400 degree F), fiberglass fabric (up to 1000 degree F), Silica fabric (up to 2000 degree F), and Alumina (up to 2300 degree F). These selected fire proof

1. A locking fire containment box for extinguishing electronic thermal runaway events in portable electronic devices operating on ionic batteries; comprising:
a battery containment chest defining a pair of side panels, a front panel a rear panel and a floor collectively defining an inner cavity, said side panels, front panel and rear panel further defining a top edge providing a reenforced upper rim;
a locking lid proportionally fitted to said reenforced upper rim of said battery containment chest, said locking lid further defining a pair of reinforced end margin members affixed to an upper surface of said locking lid, corresponding in location to each said side panel of said battery containment chest, a pair of depending contoured lips extending downward from a lower surface of said locking lid;
a containment chest locking base affixed to each respective side panel of said battery containment chest, each said containment chest locking base receiving a respective lid locking plate pivotally engaging a respective reinforced end margin member defining at least one lid locking means of a mechanical engagement and forming an air-tight and liquid-tight seal between said lower surface of said locking lid and said reinforced upper rim of said battery containment chest; and
afire proof liner contoured to be fitted within said inner cavity of said battery containment chest, said inner cavity containing a quantity of an ionic battery suppression liquid within which a portable electronic device experiencing a thermal runaway event may be emersed to halt the thermal runaway event, wherein said electronic device, once the thermal runaway event becomes active, is placed within said fire proof liner containing said ionic battery suppression liquid after which said locking lid is lockingly engaged upon said battery containment chest, said at least one lid locking means is mechanically engaged, and said ionic battery emersed within said ionic battery suppression liquid within said fire proof liner is neutralized in a controlled and contained extinguishing environment.

2. The locking fire containment device of claim 1, said locking fire containment further providing a portable truck defining a frame attached to said rear panel, said portable truck defining a set of lower wheel and an upper handle lock extension providing said upper handle lock extension to be raised to a level allowing grip for transport of said locking fire containment device in mobile transport to said portable electronic device location.

3. The locking fire containment device of claim 1 wherein said ionic battery suppression liquid is a selection from of group of liquid chemicals including ethylene glycol monophenyl ether a/k/a 2-Phenoxyethanol, phenoxyethanol, phenoxytolarosol, DOWANOL® EP/EPH, Protectol PE, Emery 6705, rose ether, 1-Hydroxy-2-phenoxyethane, β-hydroxyethyl phenyl ether, phenyl cellosolve, PHENOXETOL® or phenetole.

4. The locking fire containment device of claim 1, said fire proof liner is a selection from a group of materials or a blend of materials comprising Aramid, fiberglass fabric, Silica fabric, Alumina, ceramic oxide insulation fabrics combined with woven fiberglass, aluminized fabrics, Z-BLOCK ® flame retardant fabrics, Z-SHIELD® acrylic coated welding fabrics, Z-TUFF® silicone fabrics, and KEVLAR®.

5. The locking fire containment device of claim 1, further comprising:
said lid locking plate further defines a side bracket pivotally engaging a respective reenforced end margin member and an upper handle lock extension and further extending a lower grip tab; and
said containment chest locking base defining a side engagement plate and an upper lock flange within which a respective upper handle lock extension is place and further removably secured to create said air-tight seal between said lower surface of said locking lid and said reinforced upper rim of said battery containment chest.

6. The locking fire containment device of claim 1, said fire proof liner further comprising an air-tight closure means including a pull tab, zipper, or zip-lock with capacity to be opened quickly to place said portable electronic device within said ionic battery suppression liquid is pre-filled until opened through said airtight closure means of said fire proof liner.

7. The locking fire containment device of claim 1, further comprising said upper surface attached a fire extinguisher mounting bracket containing a portable fire extinguisher for deployment of said contents to pre-cool said portable electronic device experiencing said ionic batter thermal runaway event is already too hot to touch prior to placement of said portable electronic device within said fireproof liner within said inner cavity of said battery containment chest.

8. The locking fire containment device of claim 1, further comprising any other element or combination of elements as disclosed in the specification and drawings.
